(19) United States
(12) Patent Application Publication
(10) Pub. No.: US 2025/0067910 A1
(43) Pub. Date: Feb. 27, 2025

(54) MAGNETICALLY TUNABLE OPTOFLUIDIC LENS

(71) Applicant: OKINAWA INSTITUTE OF SCIENCE AND TECHNOLOGY SCHOOL CORPORATION, Kunigami-gun, Okinawa (JP)

(72) Inventors: Jason Mark TWAMLEY, Kunigami-gun, Okinawa (JP); Daehee KIM, Kunigami-gun, Okinawa (JP); Mathieu COUILLARD, Kunigami-gun, Okinawa (JP)

(73) Assignee: OKINAWA INSTITUTE OF SCIENCE AND TECHNOLOGY SCHOOL CORPORATION, Kunigami-gun, Okinawa (JP)

(21) Appl. No.: 18/727,052

(22) PCT Filed: Jan. 5, 2023
(86) PCT No.: PCT/JP2023/000109

§ 371 Date: Jul. 5, 2024

Related U.S. Application Data
(60) Provisional application No. 63/297,178, filed on Jan. 6, 2022.

(51) Int. Cl. G02B 3/14; G02B 1/00; G02B 26/00

(52) U.S. Cl. CPC G02B 3/14; G02B 1/00; G02B 26/004

(57) ABSTRACT

One or more first magnets and one or more second magnets are separated along an optical axis. A diamagnetic lens droplet is suspended in the paramagnetic medium. Strength, direction, and/or position of the one or more first and second magnets are adjusted to change the shape of the lens droplet or the position of the lens droplet along the axis. The one or more first magnets and one or more second magnets may include pairs of magnets offset from one another along axes that are perpendicular to one another and the optical axis. Pairs of intermediate magnets may be positioned between the one or more first magnets and one or more second magnets and adjust the offset of the lens droplet relative to the optical axis. An interface between layers of diamagnetic and paramagnetic fluids may be shaped by concentric ring magnets in order to implement a tunable lens.

### TECHNICAL FIELD

The present invention relates to tunable optofluidic lenses.

### BACKGROUND ART

Although a conventional lens can be made with great accuracy, the optical characteristics of a lens assembly is typically required to be adjusted dynamically and accurately to achieve a desired focal length and field of view. Adaptation of a lens assembly may be used to change the depth of focus to correspond to the location of an object being imaged. A lens assembly may also be adjusted to change the amount of a frame occupied by an object, e.g. zoom.

In conventional lens assemblies, zoom control is implemented using fixed focal length optical components by mechanically adjusting the relative positions of optical components. Such mechanically adjustable assemblies have been miniaturized for various applications [1].

Some recent work has sought to achieve lenses having adjustable shapes in order to dynamically change their optical properties. These approaches focus on (i) dynamically changing the refractive index of the lens material or (ii) changing the physical shape of the lens. Although some solid-state lenses have been designed [2], most of such approaches make use of a liquid (“optofluidic”) lens. In a first approach, optical properties of optofluidic lenses may be changed by mixing two types of liquids [3]. In a second approach, the interface between two immiscible fluids (liquid or gas) is varied. Optofluidic lenses according to the second approach may be achieved by encasing a fluid in a flexible clear membrane. In the second approach, the interface between the fluids may be adjusted by changing the relative hydrodynamic pressure between the two fluids [4] or by applying electrostatic forces, dielectrophoresis, or other adjustment force [1, 5, 6].

Many lenses, including optofluidic lenses, suffer from optical aberrations such as spherical aberration, astigmatism, and others. For optofluidic lenses, proposed solutions to these aberrations include using a static preformed aspherical surface in an optofluidic cavity [7], using electrostatic forces to globally [8] or locally [9] deform the interface between the two fluids, using piezoelectric materials to deform the interface [10], or using a specially formed aspherical flexible membrane [11].

Most prior implementations of optofluidic lenses do not provide the ability to perform beam-steering using an optofluidic lens. Some approaches have attempted to perform beam steering using dielectric elastomer [12] or modulation using electrowetting [5, 13].

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF DRAWINGS

FIG. 1 is a schematic representation of a magnetically tunable optofluidic lens in accordance with an implementation.

FIG. 2 is a schematic representation of a magnetically tunable and steerable optofluidic lens in accordance with an implementatio-n.

According to FIG. 1 or FIG. 2 in accordance with an implementation.

FIG. 3 is a schematic representation of another magnetically tunable optofluidic lens in accordance with an implementation.

FIG. 4 is a schematic representation of another magnetically tunable optofluidic lens in accordance with an implementation. FIG. 4A is a side view of a chamber including diamagnetic and paramagnetic fluid in accordance with an implementation.

FIG. 4B is a side view of a chamber including diamagnetic and paramagnetic fluid in accordance with an implementation.

FIG. 4C is a side view of a chamber including diamagnetic and paramagnetic fluid in accordance with an implementation.

FIG. 4D is a side view of a chamber including diamagnetic and paramagnetic fluid in accordance with an implementation.

FIG. 5 is a schematic block diagram of a control architecture including a lens.

### DESCRIPTION OF EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

An optofluidic lens includes a first fluid and a second fluid that define an interface and have different indexes of refraction. The first fluid is diamagnetic and the second fluid is paramagnetic. The first fluid may be a droplet suspended in the second fluid. Alternatively, the first fluid and the second fluid may be arranged in layers. One or more electromagnets are positioned on either side of the first fluid and the second fluid and include openings for allowing light to pass through the electromagnet(s) and the first fluid and the second fluid. The magnetic field(s) exerted on the first fluid and the second fluid by the electromagnet(s) are used to change the shape of the interface between the first fluid and the second fluid. Where the first fluid is a droplet, the magnetic field(s) may change one or more of the shape, position, or beam angle of the droplet.

Magnetically Tunable Optofluidic Lens with Tunable Shape and Position

The celebrated Earnshaw's theorem states that one cannot engineer a static magnetic field that can hold a ferromagnetic object in a stable equilibrium position in three dimensions. However, this theorem does not hold for diamagnetic materials which possess a negative magnetic susceptibility. This led Berry and Geim to propose diamagnetic levitation in 1997 [14-16]. Many organic materials have a very weak level of diamagnetism. Materials such as graphite and bismuth possess some of the largest diamagnetic properties but liquids like water and toluene are also diamagnetic. The levels of diamagnetism in these materials, however, are naturally only very small. To exert forces large enough to compensate for gravity would require very large magnetic fields and field gradients. However, by immersing such diamagnetic materials in an external medium that is highly paramagnetic and which has a similar density, one can increase the lifting forces through buoyancy and increased magnetic contrast. Magnetic levitation via such effects is more commonly known as magneto-Archimedes levitation. This was first experimentally demonstrated in 1998 when researchers magnetically levitated a ball of water in air [17-19], using very large magnetic fields and gradients and further demonstrated the levitation of gold in liquid oxygen [20]. More recently, researchers demonstrated how the magneto-Archimedes effect could be used in chemistry and material science to provide accurate density measurements. They found that the levitation height of a diamagnetic object when magnetically levitated in a paramagnetic liquid depended very sensitively on the object's density [21-23]. This could be used to quickly and easily measure the density of microparticles and powders and can thus form an easy analytical test for illicit drugs [24]. A lengthy review of the use of magneto-Archimedes for use in chemistry has recently been published [25]. Whereas the 1998 experiment to levitate a ball of water in air required massive magnetic fields, researchers were able to levitate small droplets of diamagnetic organic liquids within a surrounding immiscible aqueous-based paramagnetic liquid using much lower magnetic fields, fields produced by NdFeB permanent magnets [26]. Many of the diamagnetic organic fluids levitated in such setups, such as 2-nitrotoluene, chlorobenzene, 3-chlorotoluene, fluorobenzene, and 4-methyl anisole, are colorless and transparent. Once trapped and levitated these objects were trapped indefinitely by the magnetic fields without the aid of any external power source.

In the optofluidic lenses described below, the liquid for the lens (“lens droplet”) is held as a free form levitated bubble within a paramagnetic medium. The shape, position and orientation of the lens droplet are controlled by applying magnetic forces to the paramagnetic medium and on the lens droplet when formed of a diamagnetic material. The magnetic forces provide a volumetric force to counter gravity and buoyancy forces to move the lens droplet to a desired position.

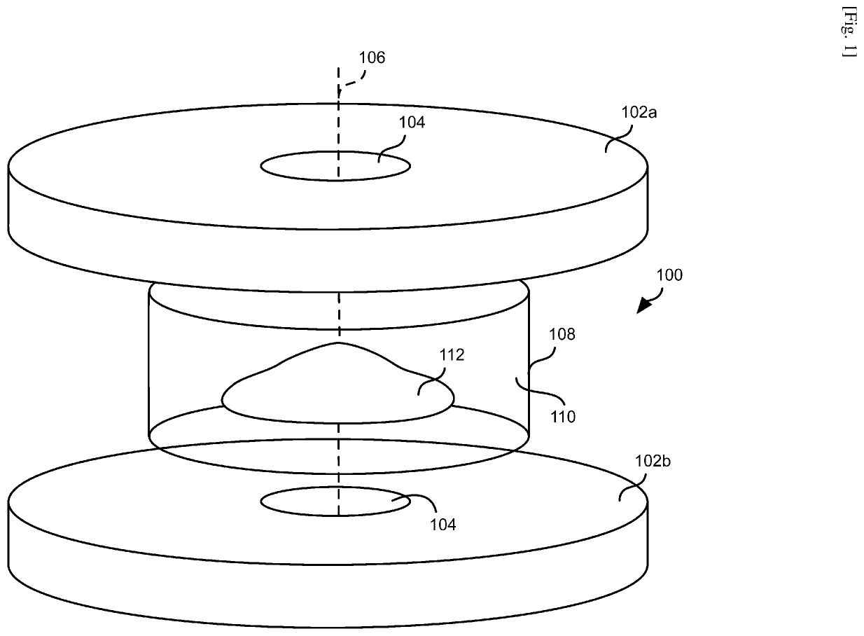

Referring to FIG. 1, a magnetically tunable optofluidic lens system 100 (“system 100”) may include an upper (also referred to herein as a “first”) electromagnet 102a and a lower (also referred to herein as a “second”) electromagnet 102b. Each electromagnet 102a, 102b may be generally circular and cylindrical (e.g., “generally circular” and “generally cylindrical” meaning each point on an outer perimeter lying within 0.1R of a circle or cylinder, respectively, where R is the radius of the circle or cylinder). Each electromagnet 102a, 102b may include a coil of wire, such as copper wire. The wire may be wound around a ferromagnetic material, such as iron (e.g., ferrite). The electromagnets 102a, 102b may include permanent magnets, such as rare earth magnets, iron magnets, or other types of magnets. In other embodiments, magnetic fields are generated exclusively through current passing through the wires of the electromagnets 102a, 102b. The electromagnets 102a, 102b may also be segmented into a number of co-axial ring type magnets which permit the fine tailoring of the generated magnetic field.

The electromagnets 102a, 102b may each define an opening 104 to permit light to pass through the electromagnets 102a, 102b. In some embodiments, transparent inserts may be positioned within the openings 104, such as glass or transparent plastic. As used herein “transparent” may be understood as transparent (e.g., at least 95, 97, or 99% transmission) in the human-visible spectrum. In some embodiments, a lens may be transparent in another portion of the electromagnetic spectrum, such as infrared, ultraviolet, or other portion of the electromagnetic spectrum.

The electromagnets 102a, 102b may define an axis 106. The generally circular or cylindrical shape of the electromagnets 102a, 102b may be substantially centered (e.g., within 0.05R) on the axis 106 and have an axis of symmetry substantially parallel (e.g., “substantially” with respect to an angle as used herein may be understood as within 5 degrees of the angle) to the axis 106. Each coil of the wires of the electromagnets 102a, 102b may be a circle or helix substantially centered on the axis 106. The openings 104 of the electromagnets 102a, 102b may also have axes of symmetry substantially centered on and substantially parallel to the axis 106 (e.g., “substantially” with respect to as distance as used herein may be understood as within 1 mm, 0.1 mm, 0.01 mm, or 0.001 mm).

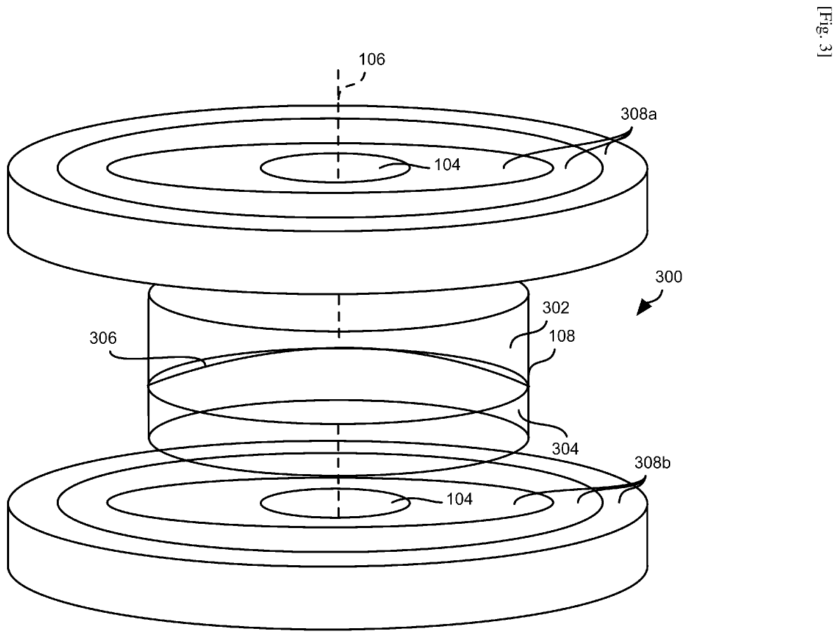

The system 100 may include a chamber 108 positioned between the electromagnets 102a, 102b. The chamber 108 may be formed of a transparent material, such as a transparent plastic or glass. The chamber 108 may have planar upper and lower walls (flat walls with surfaces substantially perpendicular to the axis 106. In other embodiments, one or both of the upper wall and lower wall may have a curved upper surface and/or a curved lower surface such that one or both of the upper wall and the lower wall form a lens. The chamber 108 may be cylindrical, cuboid, or have some other shape. In some embodiments, the electromagnets 102a, 102b (and other electromagnets for the embodiment of FIG. 3) define the chamber 108 such that a separate structure is not used.

The chamber 108 may be partially or completely filled with a paramagnetic medium 110 and a lens droplet 112. In some embodiments, the lens droplet 112 includes a diamagnetic material. Both the paramagnetic medium 110 and lens droplet 112 may be transparent. The paramagnetic medium 110 and lens droplet 112 may have different indexes of refraction such that bending occurs for non-perpendicular light rays incident at non-perpendicular angles to the interface between the paramagnetic medium 110 and lens droplet 112. For example, the difference between the indexes of refraction may be at least 0.1, at least 0.2, at least 0.5, or at least 0.7. For example, most organic liquids have a refractive index between 1 and 2. The lens droplet 112 and paramagnetic medium 110 may be immiscible or separated by a membrane.

In some embodiments, the paramagnetic medium 110 includes MNCl2 or GdCl3. The lens droplet 112 may include diamagnetic fluids such as water, toluene, 2-nitrotoluene, chlorobenzene, 3-chlorotoluene, fluorobenzene, and 4-methyl anisole.

In the presence of an electromagnetic field exerted by the electromagnets 102a, 102b, the paramagnetic medium 110 is magnetically attracted to the electromagnets 102a, 102b. In contrast, the lens droplet 112 is either not subject to the attraction of the electromagnets 102a, 102b or is subject to an opposite force in the case where the lens droplet 112 is made of a diamagnetic material. As a result, the magnetic fields of the electromagnets 102a, 102b exert a volumetric force on the lens droplet 112 that can be controlled to change the position of the lens droplet 112 along the axis 106 and change the shape of the lens droplet 112. The shape and position of the lens droplet 112 may therefore be a function of these volumetric forces, gravitational and buoyancy forces, and interfacial surface tension at the interface between the paramagnetic medium 110 and the lens droplet 112. Where a membrane separates the paramagnetic medium 110 and lens droplet 112, the elasticity of this membrane may resist deformation due to volumetric forces in the place of interfacial surface tension as used elsewhere herein.

For example, let Ma be the magnetic field exerted by the electromagnet 102a and Mb be the magnetic field exerted by the electromagnet 102b. To change the shape of the lens droplet 112, the fields Ma and Mb are increased simultaneously or decreased simultaneously in opposite directions. The field Ma and Mb may remain substantially identical (e.g., “substantially identical meaning within 5 percent, 2 percent, 1 percent, or 0.1 percent) to avoid adjusting the position of the lens droplet 112. Alternatively, inequality may be induced to move the lens droplet 112 as well as change its position.

The fields Ma and Mb may be simultaneously increased. For example, if the magnitude of Ma and Mb are simultaneously made more attractive to the paramagnetic medium 110 (and more repellant to the lens droplet 112 when diamagnetic), this results in the lens droplet 112 being made flatter, e.g., extend outwardly more from the axis 106. If the magnitude of Ma and Mb are simultaneously decreased, this results in the lens droplet 112 being made rounder, e.g., drawn inwardly toward the axis 106.

The tendency of the lens droplet 112 to draw inwardly may be a function of the interfacial surface tension at the interface between the paramagnetic medium 110 and the lens droplet 112. The interfacial surface tension attempts to force the lens droplet 112 into a sphere. The stronger this tension is, the more the fluid of the lens droplet 112 is forced into a spherical shape. The magnetic force attracting the paramagnetic medium 110 toward the electromagnets 102a, 102b results in opposing volumetric forces on the lens droplet 112 that tend to form the lens droplet 112 into a lens shape, such as a biconvex lens. The balance of the interfacial tension and the volumetric forces therefore determines the shape of the lens droplet 112 and can be adjusted by changing the strength and direction of the magnetic fields Ma, Mb.

The magnetic fields generated by the electromagnets 102a, 102b may be curved in the vicinity of the chamber 108, which may facilitate forming the lens droplet 112 into a flattened lens shape. The volumetric forces resulting from the curved magnetic fields may tend to urge the interface between the paramagnetic medium and the lens droplet 112 to lie on the curved magnetic field lines, with the interfacial surface tension tending to urge the interface away from the magnetic field lines and toward a spherical shape.

In some embodiments, the electromagnets 102a, 102b are each made of a series of two, three, or more, rings, each ring being generally circular or generally cylindrical. The rings may be nestable in a concentric manner. Each ring may include coils that can be activated (e.g., supplied with current) independent of the other rings. In this manner, the magnetic field generated by each ring can be independently controlled. The shape of the magnetic field lines within the volume between the electromagnets 102a, 102b may be controlled by controlling the amount of current supplied to each ring of each electromagnet 102a, 102b in order to sculpt the surface of the lens droplet 112 to a desired shape.

To adjust the position of the lens droplet 112 along the axis 106, the fields Ma and Mb are adjusted to change one or both of the difference (e.g., |Ma|−|Mb|) or the ratio (e.g., |Ma|/|Mb|) of the fields Ma and Mb. The difference and/or ratio may be adjusted such that a net volumetric force toward the electromagnet 102a or electromagnet 102b is exerted on the lens droplet 112. For example:
if |Ma|/|Mb| is greater than one and/or |Ma|−|Mb| is positive, the lens droplet 112 will be urged toward the electromagnet 102b.
If |Ma|/|Mb| is less than one and/or |Ma|−|Mb| is negative, the lens droplet 112 will be urged toward the electromagnet 102a.

In operation, adjustments to the magnetic fields Ma, Mb to change the position of the lens droplet 112 may be transitory: once positioned the lens droplet 112 may remain at this position such that the magnitudes and directions magnetic fields Ma, Mb may then be changed to achieve a desired shape of the lens droplet 112 and remain at these magnitudes and directions until another adjustment of the optical properties of the lens droplet 112 is performed. In some implementations, a smaller (relative to that required to move the lens droplet 112 as discussed above) but non-zero ratio or difference in the absolute values of Ma and Mb is maintained after the lens droplet 112 is moved to a desired position in order to maintain the lens droplet 112 at the desired position. For example, the non-unit ratio or non-zero difference may be used to counteract gravity or inertial forces.

The magnitudes of Ma and Mb to obtain a desired shape of the lens droplet 112 and to achieve and maintain a desired position of the lens droplet 112 along the axis 106 may be determined experimentally. In particular, calibration may be performed to determine the amount of current within the electromagnets 102a, 102b to obtain a desired shape of the lens droplet 112 and to achieve and maintain a desired position of the lens droplet 112 along the axis 106. In addition to using calibrated current values, the current through the electromagnets 102a, 102b may be adjusted dynamically using feedback, as discussed in detail below.

Note that the magnitudes of Ma and Mb as experienced by the paramagnetic medium 110 and lens droplet 112 may additionally or alternatively be adjusted by changing the position and/or orientation of the electromagnets 102a, 102b, such as using mechanical actuators. In such embodiments, the electromagnets 102a, 102b may be embodied as permanent magnets, such as toroidal magnets. In the embodiments described herein, references to adjusting current to an electromagnet may be understood as being replaceable with adjustment of the position of the electromagnet or a substituted permanent magnet.

In some embodiments, one of the electromagnets 102a, 102b (e.g., 102b) is replaced with a permanent magnet. In this manner, electromagnet 102a may be adjusted relative to the fields of the permanent magnet 102b to achieve the desired relationship between the magnitudes of Ma and Mb for a given lens shape or change in position.

Magnetically Tunable Optofluidic Lens with Tunable Shape, Position, and Beam Angle

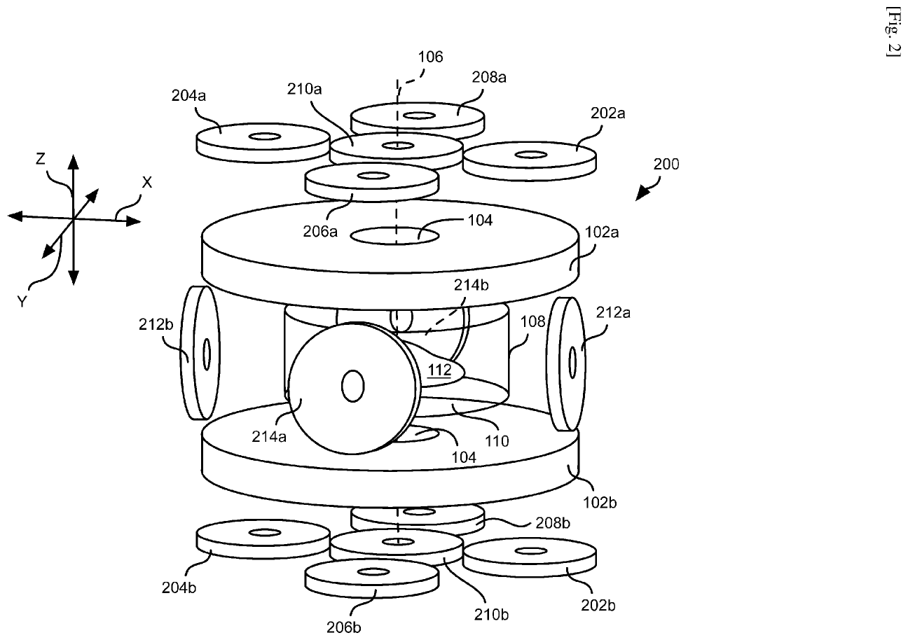

Referring to FIG. 2, in some embodiments, the orientation and offset of the lens droplet 112 relative to the axis 106 may be dynamically adjustable using the depicted system 200. The system 200 may include some or all of the components of the system 100 as described above and include additional components for adjusting one or both of the orientation and offset of the lens droplet 112 relative to the axis 106. The system 200 may be understood with respect to an X axis, Y, axis, and Z axis that are all mutually perpendicular. The Z axis may be substantially parallel to the axis 106 and may be defined as being parallel to the Z axis.

In the depicted embodiment, the chamber 108 is positioned between electromagnets 202a-210a on one side and the electromagnets 202b-210b on the other side. The electromagnets 202a-210a, 202b-210b may have some or all of the attributes of the electromagnets 102a, 102b. In the depicted embodiments, the electromagnets 202a-210a, 202b-210b are shown as smaller than the electromagnets 102a, 102b. However, in other embodiments, the electromagnets 102a, 102b are the same size or smaller than the electromagnets 202a-210a, 202b-210b. Those electromagnets 202a-210a, 202b-210b that are not intersected by the axis 106 may omit the opening 104 or the opening 104 may be covered by non-transparent material.

Electromagnets 202a, 204a are offset from one another along the X axis on either side of the axis 106. Electromagnets 206a, 208a are offset from one another along the Y axis on either side of the axis 106. Electromagnets 202b, 204b are offset from one another along the X axis on either side of the axis 106. Electromagnets 206b, 208b are offset from one another along the Y axis on either side of the axis 106. Electromagnets 210a, 210b may be centered on the axis 106 as described above with respect to the electromagnets 102a, 102b and include openings to permit light to pass therethrough. In other embodiments, electromagnets 210a, 210b are omitted and the functions ascribed herein to the electromagnets 210a, 210b are performed by the electromagnets 102a, 102b.

The axes of symmetry of the electromagnets 202a-210a, 202b-210b may be oriented substantially parallel to the Z axis. Alternatively, the axes of symmetry of the electromagnets 202a-210a may converge at a point within the chamber 108 or on an opposite side of the chamber 108 from the electromagnets 202a-210a. Likewise, the axes of symmetry of the electromagnets 202b-210b may converge at a point within the chamber 108 or on an opposite side of the chamber 108 from the electromagnets 202b-210b.

The electromagnets 202a-210a, 202b-210b may function to perform beam steering using the lens droplet 112. The electromagnets 202a-210a, 202b-210b may also be used to counter gravitational or inertial forces that are not parallel to the axis 106. As described above with respect to the embodiment of FIG. 1, magnetic fields Ma and Mb may be imposed to change the position and shape of the lens droplet 112. In a like manner, a combination of the magnetic fields of the electromagnets 102a, 102b and the electromagnets 202a-210a, 202b-210b may be used to generate resultant magnetic fields Mra and Mrb, where Mra is the superposition of the magnetic fields of electromagnets 102a, 202a-210a and Mrb is the superposition of the magnetic fields of the electromagnets 102b, 202b-210b. The resultant fields Mra and Mrb may be oriented substantially parallel to and substantially colinearly with one another. By adjusting the relative magnitude of the electromagnets 102a, 102b and the electromagnets 202a-210a, 202b-210b the orientation of this common axis may be changed.

For example, by inducing a change in magnitude between the magnetic fields generated by electromagnets 202a, 204a and inducing a similar change in magnitude between the magnetic fields generated by the electromagnets 202b, 204b the angle of the common axis in the X-Z plane may be changed. The change in magnitude between the magnetic fields generated by the electromagnets 202a, 204a may be similar in sign and size as the change in magnitude between the magnetic fields generated by electromagnets 202b, 204b, e.g. within 5 percent or 1 percent of the same size.

In another example, by inducing a change in magnitude between the magnetic fields generated by electromagnets 206a, 208a and inducing a similar change in magnitude between the magnetic fields generated by the electromagnets 206b, 208b the angle of the common axis in the Y-Z plane may be changed. The change in magnitude between the magnetic fields generated by the electromagnets 206a, 208a may be similar in sign and size as the change in magnitude between the magnetic fields generated by electromagnets 206b, 208b, e.g. within 5 percent or 1 percent of the same size.

By changing the angle of the common axis in the X-Z and Y-Z planes simultaneously, an optical axis of the lens droplet 112 may be shifted to be non-parallel to the normal vector of the X-Y plane and lie in a plane other than the X-Z or Y-Z planes.

In some embodiments, the system may include electromagnets 212a, 212b and electromagnets 214a, 214b to adjust the offset between the lens droplet 112 and the axis 106 along the X axis and Y axis, respectively. The electromagnets 212a, 212b may be offset from one another along the X axis and positioned between the electromagnets 102a, 202a-210a and the electromagnets 102b, 202b-210b along the Z axis with the chamber 108 positioned between the electromagnets 212a, 212b. The electromagnets 214a, 214b may be offset from one another along the Y axis and positioned between the electromagnets 102a, 202a-210a and the electromagnets 102b, 202b-210b along the Z axis with the chamber 108 positioned between the electromagnets 214a, 214b. Note that in some embodiments, the X and Y axis as defined for the positioning of the electromagnets 212a, 212b and electromagnets 214a, 214b may be rotated about the Z axis relative to the X and Y axis as defined above for positioning the electromagnets 202a-208a, 202b-208b.

By decreasing the magnetic field of the electromagnet 212a and increasing the magnetic field of the electromagnet 212b, the lens droplet 112 may be urged along the X axis toward the electromagnet 212a. By decreasing the magnetic field of the electromagnet 214a and increasing the magnetic field of the electromagnet 214b, the lens droplet 112 may be urged toward the electromagnet 214a along the Y axis. The relative strength of the magnetic fields of the electromagnets 212a, 212b or the electromagnets 214a, 214b may be reversed relative to these examples to urge the lens droplet 112 toward the electromagnet 212b or the electromagnet 214b.

Magnetically Tunable Optofluidic Lens with Layers of Immiscible Paramagnetic and Diamagnetic Fluids

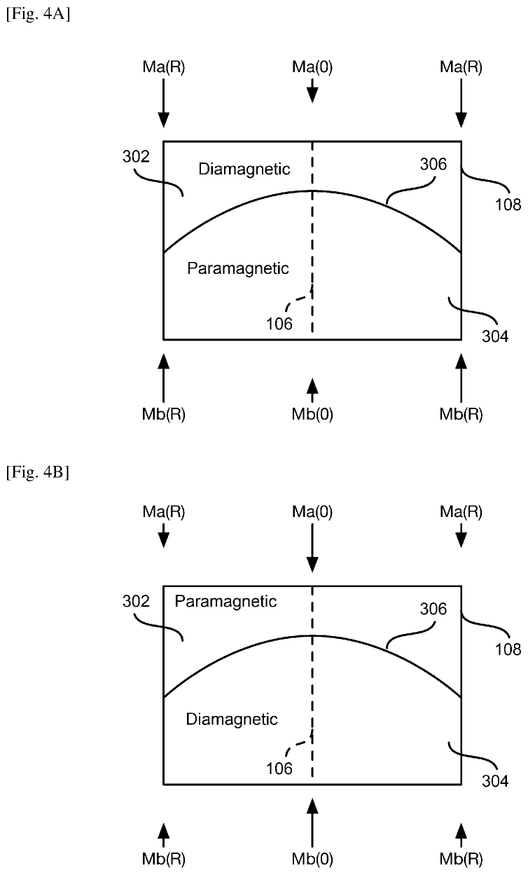

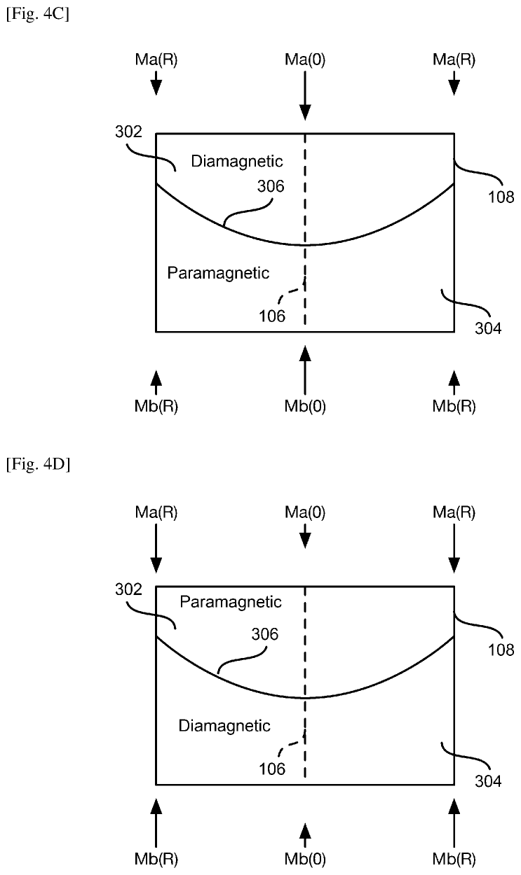

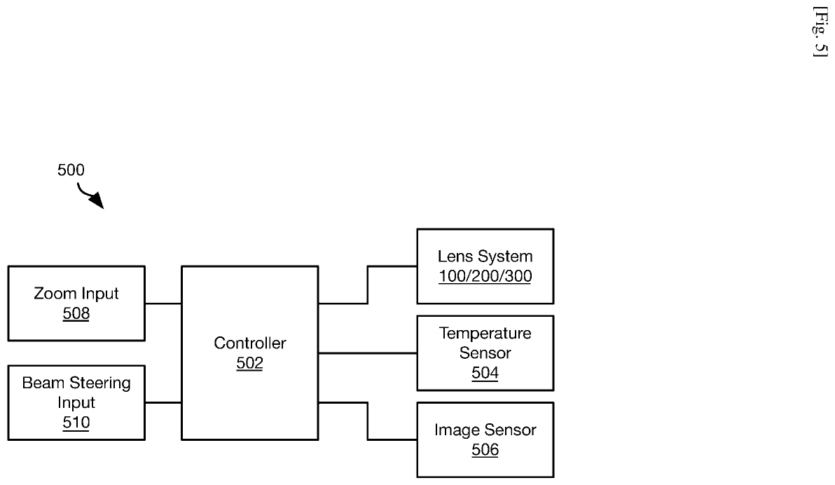

FIGS. 3 and 4A to 4D depict an alternative lens system 300. In the lens system 300, the chamber 108 contains two immiscible fluids 302, 304 in separate layers. In a first approach, one of the fluids 302, 304 is diamagnetic and the other fluid 304, 302 is neither para- nor diamagnetic. In a second approach, one of the fluids 302, 304 is diamagnetic and the other fluid 304, 302 is paramagnetic. The diamagnetic and/or paramagnetic fluids used for the fluids 302, 304 may include any of the diamagnetic and paramagnetic fluids described hereinabove.

Absent a distorting electromagnetic field, the fluids 302, 304 may arrange themselves one on top of the other along the axis 106. For example, fluid 304 may be denser than fluid 302 Alternatively, the fluid 302, 304 may adopt this arrangement due to being immiscible and being initially placed in this arrangement. In another alternative, a transparent membrane extends across the chamber and maintains the fluids 302, 304 separates from one another. The fluids 302, 304 have different indexes of refraction such that curvature of the interface 306 between the fluid 302, 304 will create a lens. For example, the difference between the indexes of refraction may be at least 0.1, at least 0.2, at least 0.5, or at least 0.7. In the depicted embodiment, only the interface 306 is curved such that no focusing occurs when light exits the chamber 108. Alternatively, the chamber 108 may have curved surfaces facing the ring electromagnets 308a and/or ring electromagnets 308b to achieve additional, though static, focusing.

In the lens system 300, the upper electromagnet 102a and lower electromagnet 102b of the previously described embodiments are replaced with a set of concentric ring electromagnets 308a, 308b, respectively. The innermost rings of the ring electromagnets 308a, 308b define the opening 104 for permitting light to pass through the lens system 300. As for other embodiments, the opening 104 may be open or filled with a transparent material. Each ring electromagnet 308a, 308b is independently supplied with current by the controller 502 (see discussion of FIG. 5, below) in order to independently control the magnetic field generated by each ring electromagnet 308a, 308b. The ring electromagnets 308a, 308b may be substantially (e.g., within 0.1 mm) concentric about a common axis 106 and may be substantially (e.g., within 0.1 mm) symmetric about the axis 106. The ring electromagnets 308a and the ring electromagnets 308b may each be arranged in a coplanar arrangement in a plane perpendicular to the axis 106. However, non-coplanar arrangement may also be used. The ring electromagnets 308a, 308b may also be used in place of the upper electromagnet 102a and lower electromagnet 102b in the embodiments of FIGS. 1 and 2.

The chamber 108 is positioned between the ring electromagnets 308a and the ring electromagnets 308b. The chamber 108 may have any of the attributes of the chamber 108 in the embodiments of FIGS. 1 and 2. Where the chamber 108 is cylindrical, the axis of symmetry of the chamber 108 may be substantially (e.g., within 0.1 mm) collinear with and substantially (e.g., within 2 degrees) parallel to the axis 106.

As for other embodiments, the chamber 108 may be offset from the ring electromagnets 308a and the ring electromagnets 308b. Alternatively, the ends of the chamber 108 offset from one another along the axis 106 may be defined by at least partially by the ring electromagnets 308a and the ring electromagnets 308b with transparent material being positioned in the opening 104 to contain the fluids 302, 304.

In the embodiments of FIGS. 1 and 2, a diamagnetic droplet 112 within a paramagnetic medium 110 is levitated and shaped to form a lens. This approach requires magnetic fields large enough to overcome interfacial tension between the droplet 112 and the paramagnetic medium 110. Although such magnetic fields are possible and feasible, the lens system 300 provides the benefit of enabling tuning using smaller magnetic fields. This enables the ring electromagnets 308a, 308b and circuits supplying power thereto to be made smaller.

In the absence of a magnetic field, the interface 306 may be flat and light passing through the openings 104 in the ring electromagnets 308a, 308b is not focused by the interface 306. The ring electromagnets 308a, 308b may be activated to deform the interface 306 in order to focus the light passing through the openings 104.

FIGS. 4A to 4D depict example modes of operation of the lens system 300. For FIGS. 4A to 4D, let the direction of light propagation be from the opening 104 in the upper ring electromagnets 308a to the opening 104 in the lower ring electromagnets 308b.

Referring specifically to FIG. 4A, let the fluid 302 be diamagnetic and the fluid 304 be paramagnetic. The ring electromagnets 308a, 308b may be driven by the controller 502 to achieve radial gradients such that Ma(r) and Mb(r) are not constant, where r is a distance from the axis 106, Ma(r) is the strength of the magnetic field generated by the ring electromagnets 308a as a function of r, and Mb(r) is the strength of the magnetic field generated by the ring electromagnets 308b as a function of r.

As shown in FIG. 4A, the magnetic fields of Ma(r) and Mb(r) may be oriented in opposite directions as for other embodiments disclosed herein. The functions used for Ma(r) and Mb(r) may be linear, parabolic, or some other function providing a desired shape of the interface 306 in order to achieve desired optical properties. The controller 502 may be programmed to supply current to the ring electromagnets 308a, 308b in order to approximate desired functions for Ma(r) and Mb(r).

In the example of FIG. 4A, the magnetic field strengths Ma(r) and Mb(r) increase as r increases such that Ma(R) and Mb(R) are much greater (e.g., between 1 and 5000 times greater)] than Ma(0) and Mb(0), respectively, where R is the radius of the interior of the chamber 108.

Because Ma(r) increases with increasing r, the fluid 302, which is diamagnetic in this example, is repelled more strongly from the ring electromagnets 308a at the perimeter of the chamber 108 than at the center of the chamber 108. The pressure of the fluid 302 is therefore lower at the perimeter of the chamber 108, which urges the fluid 302 to flow toward the perimeter of the chamber 108.

Because Mb(r) increases with increasing r, the fluid 304, which is paramagnetic in this example, is attracted more strongly at the perimeter of the chamber 108 than at the center of the chamber 108. The pressure of the fluid 304 is therefore greater at the perimeter of the chamber 108, which urges the fluid 304 to flow toward the center of the chamber 108.

The combined flow of the fluid 302 toward the perimeter and the flow of the fluid 304 toward the center causes the interface 306 to bulge toward the ring electromagnets 308a and create a concave surface encountered by the light. As the ratio of Ma(R) to Ma(0) increases, the concavity of the interface 306 will increase. Likewise, as the ratio of Mb(R) to Mb(0) increases, the concavity of the interface 306 will increase.

Referring to FIG. 4B, the interface 306 may also be caused to bulge toward the ring electromagnets 308a where the fluid 302 is paramagnetic and the fluid 304 is diamagnetic. In such a configuration, Ma(r) and Mb(r) decrease with increasing r to create a concave interface 306. In the configuration of FIG. 4B, as the ratio of Ma(0) to Ma(R) increases, the concavity of the interface 306 will increase. Likewise, as the ratio of Mb(0) to Mb(R) increases, the concavity of the interface 306 will increase.

Referring to FIG. 4C, where the fluid 302 is diamagnetic and the fluid 304 is paramagnetic, a convex interface 306 (assuming light enters through the ring electromagnets 308a) may be achieved where Ma(r) and Mb(r) decrease with increasing r. In the configuration of FIG. 4C, as the ratio of Ma(0) to Ma(R) increases, the convexity of the interface 306 will increase. Likewise, as the ratio of Mb(0) to Mb(R) increases, the convexity of the interface 306 will increase.

Referring to FIG. 4D, where the fluid 302 is paramagnetic and the fluid 304 is diamagnetic, a convex interface 306 (assuming light enters through the ring electromagnets 308a) may be achieved where Ma(r) and Mb(r) increase with increasing r. In the configuration of FIG. 4D, as the ratio of Ma(R) to Ma(0) increases, the convexity of the interface 306 will increase. Likewise, as the ratio of Mb(R) to Mb(0) increases, the convexity of the interface 306 will increase.

### Control Architecture

Referring to FIG. 5, a control architecture 500 controller 502 may be coupled to the electromagnets of the lens system 100, 200, 300 and control the operation thereof by controlling the amount of current supplied to each electromagnet and/or by controlling mechanical actuators controlling positions of the electromagnets. The lens system 200 is referenced in the following description with the understanding that the lens system 100 or 300 may be operated by the controller 502 in a like manner unless otherwise indicated.

The controller 502 may be coupled to one or more other sensors, such as a temperature sensor 504. Properties of some or all of the paramagnetic medium 110, lens droplet 112, and the electromagnets of the lens system 200 may be temperature dependent. The controller 502 may be programmed to account for this temperature dependence using outputs of the temperature sensor 504. Other sensors coupled to the controller 502 may include an inertial sensor (e.g., accelerometer) for detecting gravitational and inertial forces exerted on the lens system 200. The controller 502 may therefore be programmed to adjust current supplied to the electromagnets of the lens system 200 in order to compensate for the gravitational and inertial forces.

The controller 502 may be coupled to an image sensor 506, such as a charge coupled device (CCD). In some implementations, the controller 502 may control the shape, position, orientation, and/or offset of the lens droplet 112 based on outputs of the image sensor 506. For example, the controller 502 may be calibrated to supply current to the electromagnets of the lens system 200 for a desired focal length and/or beam angle. The image sensor 506 may output a stream of images from light detected after passing through the lens system 200. The controller 502 may receive these images and adjust the current to the electromagnets of the lens system 200 in order to improve the quality of the images. This may include performing an auto-focusing algorithm to determine a needed change in focal length, beam angle, and/or offset. The controller 502 may translate the needed change in focal length, beam angle, and/or offset into adjustments to the supplied current to the electromagnets and then implement the adjustments relative to the lens system 200. Feedback from the image sensor 506 may further enable the controller 502 to shape the lens droplet 112 to correct for spherical aberration, coma, astigmatism, or other aberrations.

The controller 502 may be coupled to control inputs for receiving control inputs from a human user or other control algorithm. The control inputs may include a zoom input 508 and a beam steering input 510. The zoom input 508 may provide a desired change in focal length (zoom in or zoom out) to the controller 502, which the controller 502 may then implement by changing the position and/or shape of the lens droplet 112 according to the approach described herein. The beam steering input 510 may provide a desired beam angle, which the controller 502 may then implement according to the approach described herein.

For the lens system 300, the controller 502 may have fewer controls than for the lens system 100 or 200. For example, the current supplied to the individual rings of the ring electromagnets 308a, 308b may be used to control the concavity or convexity of the interface 306 in order to achieve a desired focal length or magnification. However, change in the orientation of the optical axis of the lens defined by the interface 306 relative to the axis 106 and the position of the interface 306 along the axis 106 may or may not be implemented using the lens system 300.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### REFERENCES

The following references are hereby incorporated herein by reference in their entirety for all purposes:
[1]N. Ivanova, Biomimetic Optics: Liquid-Based Optical Elements Imitating the Eye Functionality, Philos. Trans. R. Soc. A Math. Phys. Eng. Sci. 378, (2020).
[2]S. Shian, R. M. Diebold, and D. R. Clarke, Tunable Lenses Using Transparent Dielectric Elastomer Actuators, Opt. Express 21, 8669 (2013).
[3]Y. C. Seow, S. P. Lim, and H. P. Lee, Optofluidic Variable-Focus Lenses for Light Manipulation, Lab Chip 12, 3810 (2012).
[4]M. Blum, M. Bu(Umlaut)eler, C. Gra(Umlaut)tzel, and M. Aschwanden, Compact Optical Design Solutions Using Focus Tunable Lenses, in Optical Design and Engineering IV, Vol. 8167 (2011).
[5]Y. Cheng, J. Cao, and Q. Hao, Optical Beam Steering Using Liquid-Based Devices, Opt. Lasers Eng. 146, 106700 (2021).
[6]Q. Chen, T. Li, Z. Li, C. Lu, and X. Zhang, Dielectrophoresis-Actuated Liquid Lenses with Dual Air/Liquid Interfaces Tuned from Biconcave to Biconvex, Lab Chip 18, 3849 (2018).
[7]J.-H. Wang, X. Zhou, L. Luo, R.-Y. Yuan, and Q.-H. Wang, Tunable Liquid Lens Integrated with Aspheric Surface, Opt. Commun. 445, 56 (2019).
[8]K. Mishra, A. Narayanan, and F. Mugele, Design and Wavefront Characterization of an Electrically Tunable Aspherical Optofluidic Lens, Opt. Express 27, 17601 (2019).
[9]Q. Chen, X. Tong, Y. Zhu, C. C. Tsoi, Y. Jia, Z. Li, and X. Zhang, Aberration-Free Aspherical in-Plane Tunable Liquid Lenses by Regulating Local Curvatures, Lab Chip 20, 995 (2020).
[10]M. C. Wapler, Ultra-Fast, High-Quality and Highly Compact Varifocal Lens with Spherical Aberration Correction and Low Power Consumption, Opt. Express 28, 4973 (2020).
[11]K. Wei, H. Huang, Q. Wang, and Y. Zhao, Focus-Tunable Liquid Lens with an Aspherical Membrane for Improved Central and Peripheral Resolutions at High Diopters, Opt. Express 24, 3929 (2016).
[12]Y. Cheng, J. Cao, C. Chen, Z. Li, C. Bao, and Q. Hao, Design and Realization of Two-Dimensional Beam Steering Actuated by Dielectric Elastomer, Opt. Commun. 127557 (2021).
[13]C. Liu, D. Wang, Q.-H. Wang, and Y. Xing, Multifunctional Optofluidic Lens with Beam Steering, Opt. Express 28, 7734 (2020).
[14]M. V. Berry and A. K. Geim, Of Flying Frogs and Levitrons, Eur. J. Phys. 18, 307 (1997).
[15]M. D. Simon and A. K. Geim, Diamagnetic Levitation: Flying Frogs and Floating Magnets (Invited), J. Appl. Phys. 87, 6200 (2000).
[16]M. D. Simon, L. O. Heflinger, and A. K. Geim, Diamagnetically Stabilized Magnet Levitation, Am. J. Phys. 69, 702 (2001).
[17]Y. Ikezoe, N. Hirota, J. Nakagawa, and K. Kitazawa, Making Water Levitate, Nature 393, 749 (1998).
[18]N. Hirota, Magneto-Archimedes Levitation and Its Application, RIKEN Rev. 44, 159 (2002).
[19]N. Hirota, M. Kurashige, M. Iwasaka, M. Ikehata, H. Uetake, T. Takayama, H. Nakamura, Y. Ikezoe, S. Ueno, and K. Kitazawa, Magneto-Archimedes Separation and Its Application to the Separation of Biological Materials, Phys. B Condens. Matter 346-347, 267 (2004).
[20]A. T. Catherall, L. Eaves, P. J. King, and S. R. Booth, Floating Gold in Cryogenic Oxygen, Nature 422, 579 (2003).
[21]K. A. Mirica, S. T. Phillips, S. S. Shevkoplyas, and G. M. Whitesides, Using Magnetic Levitation to Distinguish Atomic-Level Differences in Chemical Composition of Polymers, and to Monitor Chemical Reactions on Solid Supports, J. Am. Chem. Soc. 130, 17678 (2008).
[22]K. A. Mirica, S. S. Shevkoplyas, S. T. Phillips, M. Gupta, and G. M. Whitesides, Measuring Densities of Solids and Liquids Using Magnetic Levitation: Fundamentals, J. Am. Chem. Soc. 131, 10049 (2009).
[23]K. A. Mirica, S. T. Phillips, C. R. Mace, and G. M. Whitesides, Magnetic Levitation in the Analysis of Foods and Water, J. Agric. Food Chem. 58, 6565 (2010).
[24]C. K. Abrahamsson, A. Nagarkar, M. J. Fink, D. J. Preston, S. Ge, J. S. Bozenko, and G. M. Whitesides, Analysis of Powders Containing Illicit Drugs Using Magnetic Levitation, Angew. Chemie-Int. Ed. 59, 874 (2020).
[25]S. Ge, A. Nemiroski, K. A. Mirica, C. R. Mace, J. W. Hennek, A. A. Kumar, and G. M. Whitesides, Magnetic Levitation in Chemistry, Materials Science, and Biochemistry, Angew. Chemie-Int. Ed. 59, 17810 (2020).
[26]S. Ge and G. M. Whitesides, “Axial” Magnetic Levitation Using Ring Magnets Enables Simple Density-Based Analysis, Separation, and Manipulation, Anal. Chem. 90, 12239 (2018).

1. An apparatus comprising:
one or more first magnets;
one or more second magnets;
a first fluid and a second fluid positioned between the one or more first magnets and the one or more second magnets,
wherein the first fluid and the second fluid have different indexes of refraction and different sensitivities against magnetic force, and
wherein the first fluid and the second fluid are arranged in layers; and
a controller coupled to the one or more first magnets and the one or more second magnets, the controller configured to alter one or more properties of the first fluid and/or the second fluid by controlling magnetic forces exerted by the one or more first magnets and the one or more second magnets on the first fluid and the second fluid.

2. (canceled)

3. The apparatus of claim 1, wherein the one or more properties of the first fluid and/or the second fluid include one or more of:
a flatness of the first fluid and/or the second fluid;
a position of the first fluid and/or the second fluid;
an orientation of the first fluid and/or the second fluid relative to an optical axis; or
an offset of the first fluid and/or the second fluid relative to an optical axis.

4. The apparatus of claim 3, wherein the one or more properties of the first fluid and/or the second fluid include the flatness of the first fluid and/or the second fluid and the controller is configured to change the flatness of the first fluid and/or the second fluid by:
inducing a first change in magnitude of the magnetic forces generated by the one or more first magnets; and
inducing a second change in magnitude of the magnetic forces generated by the one or more second magnets;
wherein the first change and the second change are in opposite directions along the optical axis.

5. The apparatus of claim 3, wherein the one or more properties of the first fluid and/or the second fluid include a position of the first fluid and/or the second fluid along the optical axis and the controller is configured to change the position of the first fluid and/or the second fluid along the optical axis by:
inducing a first change in magnitude of magnetic fields Ma generated by the one or more first magnets; and
inducing a second change in magnitude of magnetic fields Mb generated by the one or more second magnets, such that one or both of |Ma|−|Mb| changes and |Ma|/|Mb| changes.

6. The apparatus of claim 1, wherein:
one of the one or more first magnets defines a first opening;
one of the one or more second magnets defines a second opening; and
an optical axis of the first fluid and/or the second fluid passes through the first opening and the second opening.

7. The apparatus of claim 1, wherein:
the one or more first magnets comprise at least one first pair of first magnets offset from one another along an X axis;
the one or more second magnets comprise at least one first pair of second magnets offset from one another along the X axis;
the one or more first magnets and the one or more second magnets are offset from one another along a Z axis that is perpendicular to the X axis;
the one or more first magnets comprise at least one second pair of first magnets offset from one another along a Y axis, the Y axis being perpendicular to the X axis and the Z axis; and
the one or more second magnets comprise at least one second pair of second magnets offset from one another along the Y axis.

8. (canceled)

9. The apparatus of claim 1, wherein the controller is configured to change an orientation of the first fluid and/or the second fluid relative to a Z axis by adjusting a position of the one or more first magnets and the one or more second magnets; or
wherein the one or more first magnets or the one or more second magnets comprise electromagnets and the controller is configured to change an orientation of the first fluid and/or the second fluid relative to the Z axis by controlling current supplied to the one or more first magnets and the one or more second magnets.

10. The apparatus of claim 1, further comprising:
a first pair of intermediate magnets offset from one another along an X axis and coupled to the controller; wherein:
the one or more first magnets and one or more second magnets are offset from one another along a Z axis that is perpendicular to the X axis; and
the first fluid and/or the second fluid are positioned between the first pair of intermediate magnets along the X axis; and
a second pair of intermediate magnets offset from one another along a Y axis and coupled to the controller, the Y axis being perpendicular to the X axis and the Z axis,
wherein the first fluid and/or the second fluid are positioned between the first pair of intermediate magnets along the Y axis.

11. (canceled)

12. The apparatus of claim 1, wherein the controller is configured to change a position of the first fluid and/or the second fluid along an X axis and a Y axis by adjusting a position of the one or more first magnets and the one or more second magnets: or
wherein the one or more first magnets or the one or more second magnets comprise electromagnets by controlling current supplied to the one or more first magnets and the one or more second magnets.

13. A method comprising:
creating an interface between a first fluid and a second fluid, wherein the first fluid and the second fluid have different sensitivities against magnetic force; and
applying magnetic forces to the first fluid and the second fluid by one or more magnets to change a shape of an interface between the first fluid and the second fluid.

14. The method of claim 13, further comprising applying the magnetic forces to change optical properties of the first fluid and/or the second fluid, the optical properties include one or more of:
a flatness of the first fluid and/or the second fluid;
a position of the first fluid and/or the second fluid;
an orientation of the first fluid and/or the second fluid relative to an optical axis; and
an offset of the first fluid and/or the second fluid relative to an optical axis.

15. The method of claim 14, wherein the one or more magnets define at least one opening, an optical axis of the first fluid and/or the second fluid intersecting the at least one opening.

16. The method of claim 13, wherein the one or more magnets include a first magnet and a second magnet, the first fluid and the second fluid being positioned between the first magnet and the second magnet.

17. The method of claim 13, wherein the one or more magnets include a plurality of pairs of magnets positioned around the first fluid and the second fluid such that, for each axis of three orthogonal axes, magnets of at least one pair of magnets of the plurality of pairs of magnets are offset from one another along each axis.

18. The method of claim 13, wherein:
the one or more magnets comprise a first set of ring magnets and a second set of ring magnets, the first fluid and the second fluid being positioned between the first set of ring magnets and the second set of ring magnets;
applying the magnetic forces to the first fluid and the second fluid comprises independently supplying current to each ring magnet of the first set of ring magnets and/or independently adjusting a position of each ring magnet of the first set of ring magnets such that a magnetic field strength of the first set of ring magnets has a first predefined radial gradient; and
applying the magnetic forces to the first fluid and the second fluid comprises independently supplying current to each ring magnet of the second set of ring magnets and/or independently adjusting a position of each ring magnet of the second set of ring magnets such that a magnetic field strength of the second set of ring magnets has a second predefined radial gradient,
wherein each ring magnet of the first set of ring magnets includes electromagnet and permanent magnet and each ring magnet of the second set of ring magnets includes electromagnet and permanent magnet.

19. The method of claim 16, wherein the first magnet and the second magnet are each made of two or more rings, and the rings are circular or cylindrical, and the rings are nestable in a concentric manner.

20. The method of claim 13, wherein the first fluid includes diamagnetic fluid and the second fluid includes paramagnetic fluid.

21. The apparatus of claim 1, wherein the first magnets and the second magnets are each made of two or more rings, and the rings are circular or cylindrical, and the rings are nestable in a concentric manner.

22. The apparatus of claim 1, wherein the controller is configured to shape the first fluid and/or the second fluid to correct for spherical aberration, coma, astigmatism, or other aberrations.

23. The apparatus of claim 1, wherein the first fluid is suspended in the second fluid.

24. The apparatus of claim 1, wherein the first fluid and/or the second fluid are colorless and transparent.

25. The apparatus of claim 1, further comprising an image sensor coupled to the controller, the controller configured to control magnetic forces exerted by the one or more first magnets and the one or more second magnets according to one or more outputs of the image sensor.

26. The apparatus of claim 1, wherein the first fluid includes diamagnetic fluid and the second fluid includes paramagnetic fluid.
